(19) United States
(12) Patent Application Publication
(10) Pub. No.: US 2026/0117073 A1
(43) Pub. Date: Apr. 30, 2026

(54) PELLETIZED PAVEMENT MARKING COMPOSITION

(71) Applicant: Alamo Roadway Materials, LLC, San Antonio, TX (US)

(72) Inventor: Robert W. Greer, IV, Lexington, NC (US)

(73) Assignee: Alamo Roadway Materials, LLC, San Antonio, TX (US)

(21) Appl. No.: 19/373,333

(22) Filed: Oct. 29, 2025

Related U.S. Application Data
(60) Provisional application No. 63/714,193, filed on Oct. 31, 2024.

(51) Int. Cl. C09D 5/33; C09D 7/61; C09D 7/65

(52) U.S. Cl. CPC C09D 5/004; C09D 7/61; C09D 7/65

(57) ABSTRACT

A pelletized pavement marking composition may be provided. The pavement marking composition has good adherence to a roadway, is abrasion and chemical resistant, avoids undesirable solvents, has adaptability to surface and temperature conditions. Moreover, the pavement marking composition in pelletized form avoids clumping and agglomeration prior to application. The pelletized pavement marking composition also may have lower dust levels. The composition may include 5 to 25 percent by weight maleic modified rosin ester, 0.1 to 3 percent by weight modified polyamide resin, 0.25 to 5 percent by weight rheology modifier, 0.25 to 5 percent by weight plasticizer, 0.25 to 5 percent by weight wax, 0.1 to 15 percent by weight pigment, 20 to 60 percent by weight antiblocking agent, and 20 to 60 percent by weight glass beads.

### RELATED APPLICATION

The present application claims priority from U.S. Provisional Application No. 63/714,193 filed Oct. 31, 2024, the disclosure of which is incorporated herein by reference in its entirety.

### FIELD

The present application relates to a pelletized pavement marking composition.

### BACKGROUND

Markings for pavement utilized by motorists and pedestrians traditionally have been paint. Surface and ambient conditions result in the paint having several requirements. The paint should adhere to the roadway surface, resist chemical attack by water or salt, be abrasion resistant, avoid the use of potentially toxic solvents, having long-term weather resistibility, having ability to be applied under a wide variety of ambient temperature and road surface conditions, and have flexibility to adapt to road surface expansion and contraction.

Thermoplastic pavement marking compositions may provide one or more of these requirements. Such pavement marking compositions may be available in particulate or pellet forms. Thermoplastic pellets, however, may have the tendency to clump or block when ambient temperature is above 30° C., namely in the summer, particularly during transport. The pellets may become sticky and agglomerate together, and such is exacerbated during storage at high temperature of summer.

Coating with a wax, silane, silicone or calcium carbonate may provide reduction in clumping and agglomeration. These coatings, however, often create undesirable dust.

A number of compositions have been proposed for pavement marking compositions. U.S. Pat. No. 10,214,649 B2 to Greer, et al. proposes a hot applied thermoplastic marking composition. U.S. Pat. No. 11,702,804 B2 to Rajendran, et al. proposes a pelletized road marking composition comprising a binder, a filler and bentonite clay. The addition of bentonite is necessary to allow storage of the polymeric pellets in any ambient conditions, particularly the heat of the summer or the tropics.

### SUMMARY

The pelletized pavement marking composition of the present disclosure provides improvements over existing compositions providing the various surface and ambient condition requirements of pavement marking compositions. The marking composition of the present disclosure composition may include 5 to 25 percent by weight maleic modified rosin ester, 0.1 to 3 percent by weight modified polyamide resin, 0.25 to 5 percent by weight rheology modifier, 0.25 to 5 percent by weight plasticizer, 0.25 to 5 percent by weight wax, 0.1 to 15 percent by weight pigment, 20 to 60 percent by weight, antiblocking agent, and 20 to 60 percent by weight glass beads. An antiblocking coating or additional antiblocking agent may be included and may be 0.1 to 1.0 percent by weight zinc stearate or calcium carbonate.

### DETAILED DESCRIPTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

The ranges used herein when referring to a measurable value such as an amount of a compound, dose, time, temperature, and the like, is meant to encompass variations of 20%, 10%, 5%, 1%, 0.5%, or even 0.1% of the specified amount. Unless otherwise defined, all terms, including technical and scientific terms used in the description, have the same meaning as commonly understood by one of ordinary skill in the art to which this invention belongs.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

As used herein, the term “consists essentially of” (and grammatical variants thereof), as applied to the compositions and methods of the present invention, means that the compositions/methods may contain additional components so long as the additional components do not materially alter the composition/method. The term “materially alter,” as applied to a composition/method, refers to an increase or decrease in the effectiveness of the composition/method of at least about 20% or more.

All patents, patent applications and publications referred to herein are incorporated by reference in their entirety. In case of a conflict in terminology, the present specification is controlling.

In accordance with the present disclosure, a pelletized pavement marking composition may be provided. The pavement marking composition has good adherence to a roadway, is abrasion and chemical resistant, avoids undesirable solvents, has adaptability to surface and temperature conditions. Moreover, the pavement marking composition in pelletized form avoids clumping and agglomeration prior to application. The pelletized pavement marking composition also may have lower dust levels. The composition may include 5 to 25 percent by weight maleic modified rosin ester, 0.1 to 3 percent by weight modified polyamide resin, 0.25 to 5 percent by weight rheology modifier, 0.25 to 5 percent by weight plasticizer, 0.25 to 5 percent by weight wax, 0.1 to 15 percent by weight pigment, 20 to 60 percent by weight antiblocking agent, and 20 to 60 percent by weight glass beads.

The maleic modified rosin ester may include maleic anhydride, a rosin acid and a rosin ester. Rosin acids are derived from gum rosin, wood rosin and toll oil rosin. Rosin acids may comprise one or more components selected from the group consisting of abietic acid, neoabietic acid, dehydroabietic acid, levopimaric acid, pimaric acid, palustric acid, isopimaric acid and sandaracopimaric acid. Rosin esters are comprised of one or more derivatives obtained from the reaction of one or more rosin acids and one or more alcohol from the group of alcohols consisting of methanol, triethylene glycol, glycerol and pentaerythritol.

Modified polyamide resins improves flexibility and impact resistance along with abrasion resistance to reduce the amount of dust. The modified polyamide resins may be polycondensation products of dimerized fatty acids and polyamines, and contain recurring amide groups (—CO—NH—) in the main polymer chain. The properties of polyamide materials are affected by the presence of highly polar amide groups and also by the length of the hydrocarbon backbone. This class of materials possesses high temperature resistance and good mechanical strength.

A higher weight di-functional primary amine may be Jeffamine® D2000, commercially available from Huntsman Corporation of Woodlands, Tex. This difunctional primary amine has amine groups located on secondary carbon atoms at the ends of an aliphatic polyether chain and is completely miscible in a wide variety of solvents, but only slightly soluble in water. Another embodiment of the present invention includes the use of amine monomers that add flexibility to the backbone in order to improve low temperature impact resistance (for example, as needed when snow plows re used over the pavement surface). In order to achieve this desired property of low temperature impact resistance, a polyetheramine is the preferred diamine.

A rheology modifier may be included to modify the viscosity and flow characteristics of the composition. Suitable examples include ethylene-vinyl acetate (EVA) copolymers, ethylene acrylate copolymers, ethylene methacrylate copolymers, ethylene acrylate glycidyl-I-acrylate copolymers. The amount of ethylene unit can range from 50 percent to 95 percent by weight and the remaining the other monomer in the copolymer. The preferred copolymer is ethylene-vinyl acetate. The vinyl acetate content can vary from 2 percent to 30 percent by weight in the copolymer. The rheology modifier may also improve the suspension of the glass beads. The desired viscosity range of the composition may be 5 Pa·s to 40 Pa·s.

Plasticizers are comprised of one or more member selected from the group consisting of vegetable oils, synthetic alkyd oils, and phthalates. Vegetable oils, called triglycerides because they are the resultant reaction of fatty acids with glycerol, and synthetic alkyd oils are made of fatty acid esters of varying composition. The fatty acids found in their structure are comprised of one or more components of the group consisting of ricinoleic acid, oleic acid, linoleic acid, linolenic acid, stearic acid, palmitic acid, dihydroxy stearic acid, myristic acid, myristoleic acid, palmitoleic acid, sapeinic acid, elaidic acid, vaccenic acid, alpha-linolenic acid, arachidonic acid, eicosapentaenoic acid, erucic acid, docosahexaenoic acid, caprylic acid, capric acid, lauric acid, arachidic acid, behenic acid, lignoceric acid, and cerotic acid. Phthalates are comprised of one or more components from the group consisting of dimethyl phthalate, diethyl phthalate, diallyl phthalate, di-n-propyl phthalate, di-n-butyl phthalate, diisobutyl phthalate, butyl cyclohexyl phthalate, di-n-pentyl phthalate, dicyclohexyl phthalate, butyl benzyl phthalate, di-n-hexyl phthalate, diisohexyl phthalate, diisoheptyl phthalate, butyl decyl phthalate, butyl(2-ethylhexyl) phthalate, di(n-octyl) phthalate, diisooctyl phthalate, n-octyl n-decyl phthalate, diisononly phthalate, di(2-prpoylheptyl) phthalate, diisodecyl phthalate, diundecyl phthalate, diisoundecyl phthalate, ditridecyl phthalate, and diisotridecyl phthalate.

A wax may be included and are selected from the group consisting of petroleum waxes or synthetic waxes. Petroleum derived waxes are comprised of one or more member selected from the group consisting of saturated n-alkanes, iso-alkanes, napthenes, alkyl-substituted aromatic compounds, and napthene-substituted aromatic compounds. Synthetic waxes can be polyethylene, Fischer-Tropsch waxes, chemically modified waxes, or amide modified waxes. Polyethylene waxes generally have the chemical formula (C₂H₄)ₙH₂ and are comprised, based on branching and chemical structure, of one or more component of the group consisting of ultra-high-molecular-weight polyethylene (UHMWPE), high-density polyethylene (HDPE), cross-linked polyethylene (PEX or XLPE), medium-density polyethylene (MDPE), linear low-density polyethylene (LLDPE), low-density polyethylene (LDPE), very-low-density polyethylene (VLDPE), and copolymers. Fischer-Tropsch waxes generally have the chemical formula (C₂H₄)ₙH₂. An exemplary polyethylene wax may be Coschem CS-42F. An antiblocking agent may be included.

Anti-blocking agents are known in the art and should be compatible with the various components of the composition with a minimum amount used to provide pellets from sticking together. Exemplary antiblocking agents include calcium carbonate, zinc stearate or combinations thereof.

The particular glass beads used depend on the applicable governmental requirement for the size, quality, amount and retro-reflectivity. The glass beads should provide continuous retro-reflectivity for extended periods. Various pigments may be included to a sufficient dark color. While not desired, at times a high colored base layer can be used which generally includes fillers or pigments such as white, yellow, red, blue, green, and the like. A white base color can be achieved by utilizing white pigment such as titanium dioxide; yellow can be achieved by utilizing cadmium yellow, nickel titanium yellow, chrome titanium yellow with organic pigment, yellow 83 being preferred; red can be achieved by utilizing cadmium red, or red iron oxide; blue can be achieved by utilizing cobalt blue or ultramarine blue; green can be achieved by utilizing cobalt green or chrome oxide green, and the like. As with the dark pigments, the amount of white pigments can be utilized up to the saturation of the base resin. As with the dark pigment fillers and/or pigments, the amount of the light colored fillers and/or pigment can also be up to the amount of saturation of the base resin. Typically, the amount of titanium dioxide may be 5 to 15 percent by weight, and the other pigments may be 0.1 to 5 percent by weight.

Optionally the composition may include a binder, for example, 0 to 25 percent pentaerythritol modified resin, maleic anhydride, a C5 hydrocarbon resin and/or a C9 hydrocarbon or blends thereof.

The pelletized marking composition may also include 1 to 30 percent by weight fillers such as large particle size calcium carbonate, silicon dioxide or corundum crystalline (Al₂O₃).

In general, the pelletized pavement marking composition may be prepared by any conventional method used for preparing marking compositions. The components of the composition may be mixed together in dry form, and melted into a molten form. The molten form may be molded in solid form in a desired shape of pellet which may be remelted at the application site at a pre-melt station or directly in the application apparatus. The pelletized composition may be coated with an antiblocking coating such as 0.1 to 1.0 percent zinc stearate calcium carbonate or a combination thereof. Additional antiblocking coating may be applied after transport in pellet form, particularly if the pellets are repackaged from a large bag or package to a smaller bag. For example, the pellets may be pre-melted at 250° F. to 400° F. and applied at 375° F. to 450° F.

### EXAMPLE

The following illustrative example is non-limiting.

Pellets are prepared by pre-blending the following blend (all percentages by weight):
15.5 percent maleic modified rosin ester
1.0 percent modified polyamide resin
1.0 percent ethylene-vinyl acetate copolymer rheology modifier
2.0 percent castor oil plasticizer
1.0 percent polyethylene wax
10.0 percent titanium oxide pigment
39.5 percent calcium carbonate antiblocking agent
30.0 percent AAHTO glass beads

The composition is extruded into a pellet form and 0.4 percent by weight zinc stearate antiblocking coating is applied to the pellet. The composition has good viscosity and bonds well to concrete. The pellets also do not stick together under conditions simulating up to 60 tons at 140° F.

Although the present approach has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present approach.

What is claimed is:

1. A pelletized pavement marking composition comprising:
a) 5 to 25 percent by weight maleic modified rosin ester;
b) 0.1 to 3 percent by weight modified polyamide resin;
c) 0.25 to 5 percent by weight rheology modifier;
d) 0.25 to 5 percent by weight plasticizer;
e) 0.25 to 5 percent by weight wax;
f) 5 to 15 percent by weight pigment;
g) 20 to 60 percent by weight antiblocking agent; and
h) 20 to 60 percent by weight glass beads.

2. The pelletized pavement marking composition of claim 1 further comprising 0 to 1.0 percent by weight of an antiblocking coating.

3. The pelletized pavement marking composition of claim 2 wherein the antiblocking agent or additional antiblocking coating is calcium carbonate zinc stearate or a blend thereof.

4. The pelletized pavement marking composition of claim 1 further comprising 0 to 25 percent by weight pentaerythritol modified resin, maleic anhydride, a C5 hydrocarbon resin and/or a C9 hydrocarbon resin or blends thereof.

5. The pelletized pavement marking composition of claim 1, wherein the rheology modifier is an ethylene copolymer.

6. The pelletized pavement marking composition of claim 5, wherein the ethylene copolymer is ethylene-vinyl acetate copolymer.

7. The pelletized pavement marking composition of claim 1, wherein the plasticizer is a vegetable oil or a phthalate ester.

8. The pelletized pavement marking composition of claim 7, wherein the vegetable oil is castor oil.

9. The pelletized pavement marking composition of claim 8, wherein the pigment is titanium dioxide.

10. The pelletized pavement marking composition of claim 1, wherein the antiblocking agent or antiblocking coating is calcium carbonate or zinc stearate or a blend thereof.

11. The pelletized pavement marking composition of claim 1, wherein the wax is a petroleum-based wax or a synthetic wax.

12. The pelletized pavement marking composition of claim 1, wherein the synthetic wax is a polyethylene wax.

13. A method for forming a paint marking on a roadway, the method comprising applying the pelletized pavement marking composition comprising of 5 to 25 percent by weight maleic modified rosin ester, 0.1 to 3 percent by weight modified polyamide resin, 0.25 to 5 percent by weight rheology modifier, 0.25 to 5 percent by weight plasticizer, 0.25 to 5 percent by weight wax, 5 to 15 percent by weight pigment, 20 to 60 percent by weight antiblocking agent, and 20 to 60 percent by weight glass beads.

14. The method of claim 13 further comprising 0 to 1.0 percent by weight of an antiblocking coating.

15. The method of claim 14 wherein the antiblocking agent or additional antiblocking coating is calcium carbonate zinc stearate or a blend thereof.

16. The method of claim 13 further comprising 0 to 25 percent by weight pentaerythritol modified resin, maleic anhydride, a C5 hydrocarbon resin and/or a C9 hydrocarbon resin or blends thereof.

17. The method of claim 13, wherein the rheology modifier is an ethylene copolymer.

18. The method of claim 17, wherein the ethylene copolymer is ethylene-vinyl acetate copolymer.

19. The method of claim 13, wherein the plasticizer is a vegetable oil or a phthalate ester.

20. The method of claim 19, wherein the vegetable oil is castor oil.

21. The method of claim 13, wherein the pigment is titanium dioxide.

22. The method of claim 13, wherein the antiblocking agent or antiblocking coating is calcium carbonate or zinc stearate or a blend thereof.

23. The method of claim 13, wherein the wax is a petroleum-based wax or a synthetic wax.

24. The method of claim 13, wherein the synthetic wax is a polyethylene wax.
